(19) United States
(12) Patent Application Publication
(10) Pub. No.: US 2023/0419418 A1
(43) Pub. Date: Dec. 28, 2023

(54) SERVER, SYSTEM AND METHOD FOR MONITORING AND REWARDING PET ACTIVITY USING METAVERSE

(71) Applicant: PUMPKIN Company Inc., Seoul (KR)

(72) Inventors: Seok Jung KIM, Seoul (KR); Do Yeon KIM, Seoul (KR); Ga On LEE, Seoul (KR)

(21) Appl. No.: 18/191,913

(22) Filed: Mar. 29, 2023

(30) Foreign Application Priority Data
Jun. 22, 2022 (KR) 10-2022-0076422
Mar. 2, 2023 (KR) 10-2023-0027988

(51) Int. Cl. G06Q 50/00

(52) U.S. Cl. CPC G06Q 50/01

(57) ABSTRACT

Provided are a server, system, and method for monitoring and rewarding a pet activity by using a metaverse. A pet activity monitoring and rewarding server using a metaverse connected to a pet terminal and a user terminal via a network to receive information of a pet includes a processor and a memory. The processor is configured to receive the information of the pet from the user terminal through the network, store the information of the pet in the memory, create an avatar of the pet in a virtual space to correspond to the information of the pet, update activity information of the avatar by using the information of the pet received from the pet terminal through the network, and provide a reward point to a user account that owns the avatar, based on the activity information of the avatar.

### TECHNICAL FIELD

The present disclosure relates to a server, system, and method for monitoring and rewarding a pet activity by using a metaverse. More particularly, the present disclosure relates to a server, system, and method for monitoring and rewarding a pet activity by using a metaverse, in which, after an avatar of a pet is created using a metaverse, a task is periodically assigned to the avatar, and a reward is provided when the pet linked to the avatar has completed the task in a real environment to thereby promote an activity of the pet linked to the avatar.

### BACKGROUND ART

The number of households raising pets continuously increases. As the number of pet owners raising pets increases, the number of pet owners who find it difficult to raise pets is also increasing. In addition, due to the accumulated difficulties of raising pets, an action of giving up raising pets, such as dissolution of adoption or abandonment of pets is increasing.

Pettech technology that provides services related to pets to address the difficulties of raising is steadily being presented. In particular, demand for pettech technology that monitors pets left alone in the house by using CCTV is increasing.

However, the monitoring method using CCTV not only cannot observe a pet out of a camera's field of view, but also cannot monitor the pet's health, emotion, exercise status, etc. and can check only the video of the pet.

Therefore, there are many cases in which a user's demand for actually monitoring a pet in real time is not satisfied, and there is no solution for monitoring the health and emotion of the pet.

There is also no solution for addressing pet owners' difficulties of raising pets and helping raising the pets.

### PRIOR ART DOCUMENTS

### Patent Document

(Patent document 0001) KR 10-2021-0147691 A (2021 Dec. 7)

### DESCRIPTION OF EMBODIMENTS

### Technical Problem

Provided is a server, system and method for monitoring and rewarding a pet activity by using a metaverse, in which an avatar linked to a pet's state may be created in a virtual space and a user may check the pet's state by checking information of the avatar.

Provided is a server, system and method for monitoring and rewarding a pet activity by using a metaverse, in which a pet may be identified using the muzzle print of the pet.

Provided is a server, system and method for monitoring and rewarding a pet activity by using a metaverse, in which an emotion and an exercise state of a pet may be estimated and may be checked through an avatar.

Provided is a server, system and method for monitoring and rewarding a pet activity by using a metaverse, in which proper raising of a pet may be promoted by assigning a task to periodically make the pet feel happy by using information of the pet's estimated emotion and exercise state.

Provided is a server, system and method for monitoring and rewarding a pet activity by using a metaverse, in which task achievement may be encouraged by providing a reward point to a user, when a task has been completed.

The technical problems of the present disclosure are not limited to the above-mentioned contents, and other technical problems not mentioned will be clearly understood by a person skilled in the art from the following description.

### Solution to Problem

According to an embodiment of the present disclosure, a pet activity monitoring and rewarding server using a metaverse connected to a pet terminal and a user terminal via a network to receive information of a pet includes a processor and a memory. The processor is configured to receive the information of the pet from the user terminal through the network, store the information of the pet in the memory, create an avatar of the pet in a virtual space to correspond to the information of the pet, update activity information of the avatar by using the information of the pet received from the pet terminal through the network, and provide a reward point to a user account that owns the avatar, based on the activity information of the avatar.

The information of the pet may include muzzle print information of the pet, and the avatar may be created to correspond to the muzzle print information.

The processor may compare an image of the muzzle print of the pet received from the user terminal with the muzzle print information stored in the memory to authenticate the identity of the pet.

The processor may receive, from the pet terminal, the information of the pet including heartbeat information and motion information of the pet, and the motion information may include one or more of a 3-axis acceleration signal and a 3-axis rotation signal that are measured according to a motion of the pet.

The activity information of the avatar may include respective pieces of information of an emotion and an exercise state of the pet that are inferred using the heartbeat information and the motion information of the pet.

The processor may infer an emotion of the pet by using a first artificial intelligence (AI) model, based on the heartbeat information, and infer an exercise state of the pet by using a second AI model, based on real-time location information of the pet and the motion information.

When receiving information of the pet from a terminal of the pet, the processor may determine that the terminal of the pet has been worn on the pet, and activate the avatar in the virtual space.

The processor may be further configured to assign a task to the activated avatar at predetermined intervals, determine whether the task has been completed, based on the activity information of the avatar, and provide the reward points to the user account when the task has been completed.

The processor may determine the reward point in proportion to a value obtained by multiplying a value randomly selected within the range of a predetermined parameter by a predetermined weight.

According to an embodiment of the present disclosure, a pet activity monitoring and rewarding system using a metaverse includes a pet terminal mounted on a pet to obtain information of the pet; a user terminal configured to obtain information of the pet or connected to the pet terminal to receive the information of the pet; and a server connected to the pet terminal or the user terminal through a network to receive information of the pet through the network, wherein the server is further configured to receives the information of the pet from the user terminal through the network, stores the information of the pet in a memory, and creates an avatar of the pet in a virtual space to correspond to the information of the pet, update activity information of the avatar by using the information of the pet received from the pet terminal through the network, and provide a reward point to a user account that owns the avatar, based on the activity information of the avatar.

According to an embodiment of the present disclosure, a pet activity monitoring and rewarding method using a metaverse performed by a system including a server, a user terminal, and a pet terminal worn on a pet to obtain and transmit information of the pet includes an operation in which the server receives information of the pet from the user terminal through a network, stores the information in a memory, and creates an avatar of the pet in a virtual space to correspond to the information of the pet, an operation in which the server updates activity information of the avatar by using the information of the pet received from the pet terminal through the network, and an operation in which the server provides reward points to a user account that owns the avatar, based on the activity information of the avatar.

The information of the pet may include muzzle print information of the pet, and the avatar may be created to correspond to the muzzle print information.

The pet activity monitoring and rewarding method using a metaverse may further include an operation in which the server compares an image of the muzzle print of the pet received from the user terminal with the muzzle print information stored in the memory to authenticate the identity of the pet.

The information of the pet received by the server from the pet terminal may include heartbeat information and motion information of the pet, and the motion information may include one or more of a 3-axis acceleration signal and a 3-axis rotation signal that are measured according to a motion of the pet.

The activity information of the avatar may include respective pieces of information of an emotion and an exercise state of the pet that are inferred using the heartbeat information and the motion information of the pet.

The pet activity monitoring and rewarding method using a metaverse may further include an operation in which the server infers an emotion of the pet by using a first AI model, based on the heartbeat information, and an operation in which the server infers an exercise state of the pet by using a second AI model, based on real-time location information of the pet and the motion information.

The pet activity monitoring and rewarding method using a metaverse may further include an operation in which, when receiving information of the pet from a terminal of the pet, the server determines that the terminal of the pet has been worn on the pet, and activates the avatar in the virtual space.

The operation of providing reward point to the user account may include an operation in which the server assigns a task to the activated avatar at predetermined intervals, an operation in which the server determines whether the task has been completed, based on the activity information of the avatar, and an operation in which the server provides the reward point to the user account when the task has been completed.

The server may determine the reward point in proportion to a value obtained by multiplying a value randomly selected within the range of a predetermined parameter by a predetermined weight.

### Effects of Disclosure

In a server, system and method for monitoring and rewarding a pet activity by using a metaverse, according to an embodiment of the present disclosure, an avatar linked to the state of a pet may be created in a virtual space, and a user may check the state of the pet by checking information of the avatar.

In addition, the pet may be identified using the pet's muzzle print.

An emotion and an exercise state of the pet may be estimated and may be checked through the avatar.

Proper raising of the pet may be promoted by assigning a task to periodically make the pet feel happy by using information of the pet's estimated emotion and exercise state.

Task achievement may be encouraged by providing a reward point to the user, when a task has been completed.

The effects of the present disclosure are not limited to the above-mentioned contents, and other effects not mentioned will be clearly understood by a person skilled in the art from the following description.

### BRIEF DESCRIPTION OF THE DRAWINGS

FIG. 1 is a conceptual diagram of a pet activity monitoring and rewarding system using a metaverse, according to an embodiment of the present disclosure.

FIG. 2 is a block diagram of a server according to an embodiment of the present disclosure.

FIG. 3 is a block diagram of a pet terminal according to an embodiment of the present disclosure.

FIG. 4 is a schematic diagram for explaining an algorithm in which a first artificial intelligence (AI) model estimates a current emotion of a pet, according to an embodiment of the present disclosure.

FIG. 5 is a schematic diagram showing a concept in which a device according to an embodiment of the present disclosure determines the state and situation of a pet by using an AI model.

FIGS. 6 through 10 are flowcharts of pet activity monitoring and rewarding methods using a metaverse according to embodiments of the present disclosure, respectively.

### DETAILED DESCRIPTION

Embodiments of the present disclosure will now be described more fully with reference to the accompanying drawings such that one of ordinary skill in the art to which the present disclosure pertains may easily execute the present disclosure. The present disclosure may, however, be embodied in many different forms and should not be construed as being limited to the embodiments set forth herein. In the drawings, elements irrelevant to the descriptions of the present disclosure are omitted to clearly explain embodiments of the present disclosure.

The terms used in the present specification are merely used to describe particular embodiments, and are not intended to limit the present disclosure. An expression used in the singular may encompass the expression of the plural, unless it has a clearly different meaning in the context.

In the present specification, it may be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

In addition, the components shown in the embodiments of the present disclosure are shown independently to indicate different characteristic functions, and do not mean that each component is separate hardware or one software component. In other words, for convenience of description, each component is listed and described as each component, and at least two components of each component may be combined to form one component, or one component may be divided into a plurality of components to perform a function. The integrated and separate embodiments of each component are also included in the scope of the present disclosure without departing from the essence of the present disclosure.

In addition, the following embodiments are provided to more clearly explain the present disclosure to one of ordinary skill in the art, and the shapes and sizes of elements in the drawings may be exaggerated for more clear description.

Hereinafter, the present disclosure will be described more fully with reference to the accompanying drawings, in which embodiments of the present disclosure are shown.

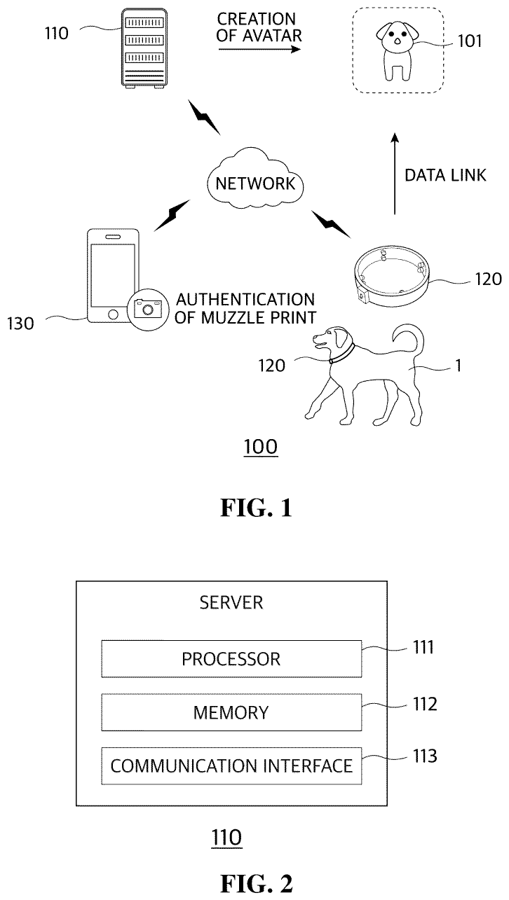

FIG. 1 is a conceptual diagram of a pet activity monitoring and rewarding system using a metaverse, according to an embodiment of the present disclosure, and FIG. 2 is a block diagram of a server according to an embodiment of the present disclosure.

Referring to FIGS. 1 and 2, a pet activity monitoring and rewarding system 100 using a metaverse, according to an embodiment of the present disclosure, is for monitoring the state and activity of a pet, and may include a server 110, a pet terminal 120, and a user terminal 130.

According to an embodiment, the server 110 and the user terminal 130 are devices including a processor, a memory, and a communication interface, and may be, but is not limited to, smartphones, tablet computers, desktop computers, laptop computers, workstations, server computers, personal digital assistants (PDAs), portable computers, handheld game consoles, navigation devices, smart TVs, wearable devices, or vehicle computers.

The pet terminal 120 may be a device equipped with a sensor module capable of obtaining heartbeat information or motion information of a pet 1.

The server 110, the pet terminal 120, and the user terminal 130 may transmit and receive respective data to and from one another through a network.

The server 110 is for monitoring the state and activity of the pet 1 by using information of the pet 1 transmitted by the pet terminal 120, and, as shown in FIG. 2, may include a processor 111, a memory 112, and a communication interface 113. The memory 112 may store software codes, and the processor 111 may execute the software codes stored in the memory 112. The processor 111 performing an operation by executing the software code will now be briefly described as the processor 111 performing the software code. The communication interface 113 may transmit and receive data through a network.

Information of the pet 1 may include one or more of the heartbeat information, the motion information, and muzzle print information of the pet 1.

According to an embodiment, the processor 111 of the server 110 may extract the muzzle print information of the pet 1 by using a muzzle print image of the pet 1 captured through the user terminal 130, and may store the extracted muzzle print information in the memory 112. The processor 111 of the server 110 may create an avatar 101 of the pet 1 so that the avatar 101 may be output to the virtual space in the metaverse, and may use the muzzle print information as a means of authenticating the identity of the pet 1 by associating the created avatar 101 with the muzzle print information. In other words, the processor 111 of the server 110 may recognize the muzzle print of the pet 1 by using artificial intelligence (AI)-based image processing technology, and may authenticate the identity of the pet 1 by comparing the image characteristics of the recognized muzzle print with the image characteristics of the muzzle print of the pet 1 stored and registered in the memory 112 of the server 110. A pet activity monitoring and rewarding system using a metaverse according to the present disclosure may more accurately recognize and process information of the pet 1 by using muzzle print recognition.

A user may perform muzzle print recognition of the pet 1 by photographing the muzzle print of the pet 1 by using the user terminal 130, and, when identity authentication is completed through the muzzle print recognition, may check the avatar 101 of the pet 1 created in the virtual space through a screen of the user terminal 130.

The pet terminal 120 is for obtaining information of the pet 1, and may be a terminal worn on the body of the pet 1 or installed on a neckband. The pet terminal 120 may obtain the information of the pet 1 including the heartbeat information or motion information of the pet 1 and may transmit the obtained information to the server 110.

According to an embodiment, when the pet terminal 120 is worn on the pet 1, the processor 111 of the server 110 may activate the avatar 101 of the pet 1. The processor 111 of the server 110 may update the information of the pet 1 transmitted by the pet terminal 120 as activity information of the avatar 101 to associate the state of the pet 1 with the state of the avatar 101. The activity information may be information of an emotion or an exercise state of the pet 1. In other words, the processor 111 of the server 110 may estimate the emotion or exercise state of the pet 1 by using the heartbeat information or motion information of the pet 1 of the pet terminal 120, and may update the estimated emotion or exercise state as the activity information of the avatar 101 of the pet 1. Depending on embodiments, the pet terminal 120 may transmit the obtained information of the pet 1 to the server 110 via the user terminal 130, or may directly transmit the obtained information of the pet 1 to the server 110. Because the user is able to check activity details or vital signs of the actual pet 1 by checking the activity information of the avatar 101 output by the user terminal 130, even when the user is far away from the pet 1, the user may check the state of the pet 1 in real time.

According to an embodiment, the processor 111 of the server 110 may assign an executable task to the activated avatar 101. The task may be a task that enables the pet 1 to have a reference number of happy emotions or more or a happy emotion to be maintained for a certain period of time or more. For example, when the pet 1 is a dog, the processor 111 of the server 110 may assign a task such as taking a walk for 20 minutes or longer, exceeding 90 points in a happiness index, or achieving a standby operation of 15 seconds, or when the pet 1 is a cat, the processor 111 of the server 110 may assign a task such as making a growling sound for 10 seconds or more, making a growling sound 5 times or more, or moving over 100 meters per day. The task may be assigned at predetermined intervals. For example, the processor 111 of the server 110 may assign the task every day.

The processor 111 of the server 110 may determine whether the task has been completed, based on the activity information of the avatar 101 linked to the pet 1. For example, the processor 111 of the server 110 may estimate or infer the emotion or exercise state of the pet 1, based on the information about the pet 1 transmitted by the pet terminal 120 worn on the pet 1, and may update the activity information of the avatar 101 with the estimated or inferred emotion or exercise state to thereby determine whether tasks such as ‘exceeding 90 points in the happiness index’ and ‘moving 100 meters per day’ have been performed.

When it is determined that the task has been completed, the processor 111 of the server 110 may provide reward points to a user account connected to the avatar 101. The user may purchase pet supplies, food, etc. or use pet hotels, beauty services, etc., by using the reward points provided after the task is completed.

According to an embodiment, the processor 111 of the server 110 may determine the reward points in proportion to a value obtained by multiplying a value randomly selected within the range of a predetermined parameter by a weight. The weight may be a level of the user account, and the parameter may be a variable that may be periodically changed during a service operation.

As such, the pet activity monitoring and rewarding system using a metaverse according to the present disclosure may periodically assign a task capable of maintaining a pet's happiness, and, when this task is completed, may provide reward points with which goods or services necessary for raising the pet may be purchased, thereby encouraging users to raise pets.

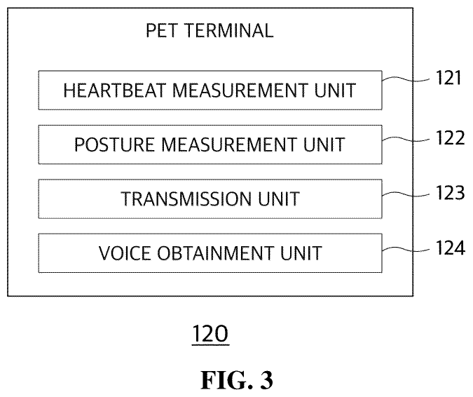

FIG. 3 is a block diagram of the pet terminal 120 according to an embodiment of the present disclosure.

Referring to FIG. 3, the pet terminal 120 according to an embodiment of the present disclosure is worn on the pet 1 to measure a bio-signal of the pet 1 in order to estimate emotional and health states of the pet 1, and may include a heartbeat measurement unit 121, a posture measurement unit 122, and a transmission unit 123.

The bio-signal of the pet 1 may be a signal obtained by measuring a heart rate, a pulse rate, a body temperature, a respiration rate, a movement, and the like of the pet 1 by using a sensor.

The heartbeat measurement unit 121 is provided to measure heartbeat information including a heartbeat signal of the pet 1, and may be a photoplethysmography (PPG) sensor or a sensor that measures a heartbeat sound and converts the measured heartbeat sound into a heartbeat signal.

The posture measurement unit 122 is provided to measure the motion information of the pet 1. For example, the posture measurement unit 122 may be an inertial measurement unit (IMU) sensor. The motion information may include one or more of a 3-axis acceleration signal and a 3-axis rotation signal that are measured according to a motion of the pet 1. The motion information measured by the posture measurement unit 122 may be used to remove noise from the heartbeat information measured by the heartbeat measurement unit 121 by using an adaptive least mean squares (LMS) filter, or may be used to estimate an exercise state of the pet 1.

The transmission unit 123 is for transmitting the heartbeat information obtained by the heartbeat measurement unit 121 and the motion information obtained by the posture measurement unit 122, and may transmit the heartbeat information and the motion information to the user terminal 130 or the server 110 depending on embodiments.

According to an embodiment, the pet terminal 120 may further include a voice obtainment unit 124 that obtains voice information of the pet 1. The transmission unit 123 may also transmit the voice information obtained by the voice obtainment unit 124.

According to an embodiment, the pet terminal 120 may be bound to a pet's neckband or may be equipped with a necklace-shaped belt.

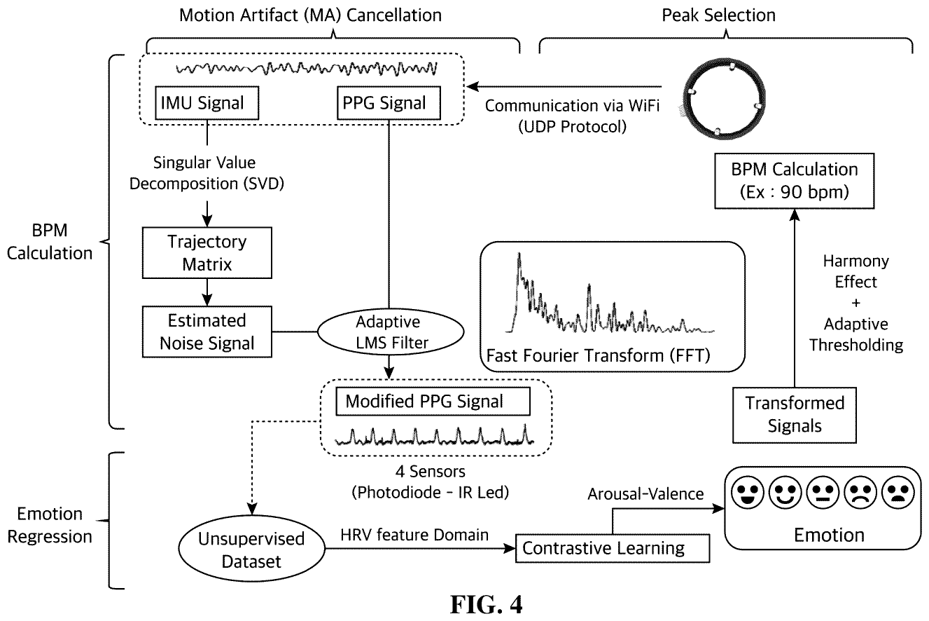

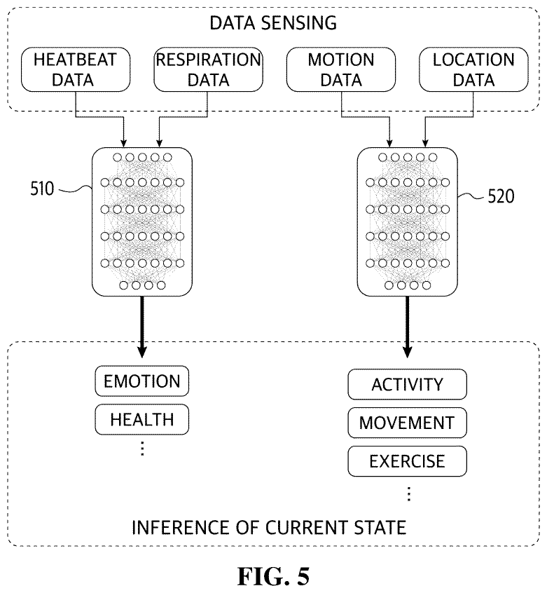

FIG. 4 is a schematic diagram for explaining an algorithm in which a first AI model estimates a current emotion of a pet, according to an embodiment of the present disclosure according to an embodiment of the present disclosure. FIG. 5 is a schematic diagram showing a concept in which a device according to an embodiment of the present disclosure determines the state and situation of a pet by using an AI model.

FIGS. 1 through 5, the processor 111 of the server 110 according to an embodiment of the present disclosure may infer the emotion of the pet 1 by using a first AI model 510, based on the heartbeat information, and may infer the exercise state of the pet 1 by using a second AI model 520, based on real-time location information of the pet 1 and the motion information.

The processor 111 of the server 110 may extract heart rate variance feature data, based on the heartbeat information received from the pet terminal 120. The heart rate variance feature data is a numerical value used for heart rate variance (HRV) analysis. The HRV analysis may include information such as Mean_NNI, SDNN, pNN50, RMSSD, Median_NN, Mean_HR, STD_HR, LF/HF ratio, and SampEn, and specific details thereof are omitted because the HRV analysis is a well-known technique.

The processor 111 of the server 110 may estimate the emotion of the pet 1, based on the extracted heart rate variance feature data, by using the first AI model 510 trained in advance. The first AI model 510 may be a classification model trained with the heart rate variance feature data labeled with different emotional states. In this case, the training may use supervised learning, and the classification model may be a multilayer extreme learning machine (MLELM).

According to an embodiment, the first AI model 510 may use contrastive learning in which the extracted heart rate variance feature data are grouped according to pre-designated time zones. At this time, unsupervised learning based on contrastive learning for learning a process of clustering similar features may be used. In the case of emotions, since emotions in nearby time zones are similar to each other, clustering learning based on a time window frame may be effective.

The processor 111 of the server 110 may estimate the exercise state of the pet 1, based on the motion information received from the pet terminal 120, by using the second AI model 520. The exercise state may be classified into a ‘resting state’, a ‘walking state’, or a ‘running state’. The motion information may include one or more of a 3-axis acceleration signal and a 3-axis rotation signal according to time. The processor 111 of the server 110 may analyze the voice information of the pet 1 obtained by the pet terminal 120. The processor 111 may analyze health information of the pet 1, based on the exercise state or voice information of the pet 1, by using the analyzed voice information, and may estimate the emotion of the pet 1 by further including the exercise state or voice information of the pet 1, from the calculated heart rate of the pet 1.

A pet activity monitoring and rewarding method using a metaverse performed by the pet activity monitoring and rewarding system using a metaverse according to the present disclosure will now be described. Redundant descriptions thereof will be briefly described.

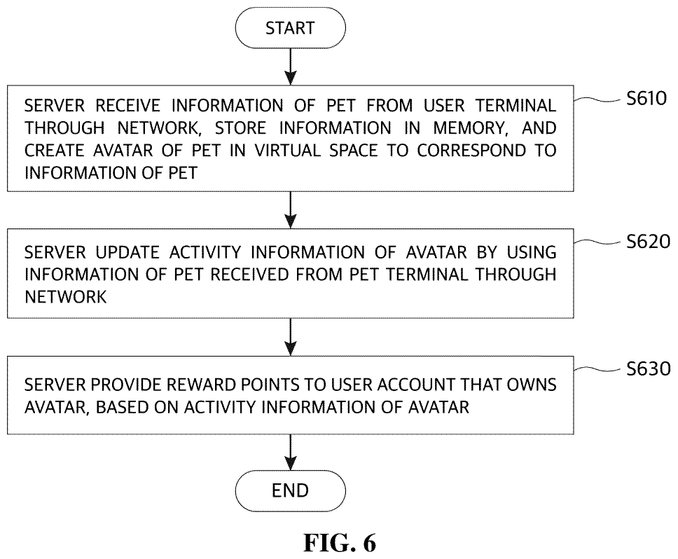

FIGS. 6 through 10 are flowcharts of pet activity monitoring and rewarding methods using a metaverse according to embodiments of the present disclosure, respectively.

Referring to FIG. 6, according to an embodiment of the present disclosure, a pet activity monitoring and rewarding method using a metaverse performed by a system including a server, a user terminal, and a pet terminal worn on a pet to obtain and transmit information of the pet includes operation S610 in which the server receives information of the pet from the user terminal through a network, stores the information in a memory, and creates an avatar of the pet in a virtual space to correspond to the information of the pet, operation S620 in which the server updates activity information of the avatar by using the information of the pet received from the pet terminal through the network, and operation S630 in which the server provides reward points to a user account that owns the avatar, based on the activity information of the avatar.

The information of the pet may include muzzle print information of the pet, and the avatar may be created to correspond to the muzzle print information.

The information of the pet received by the server from the pet terminal may include heartbeat information and motion information of the pet, and the motion information may include one or more of a 3-axis acceleration signal and a 3-axis rotation signal that are measured according to a motion of the pet.

The activity information of the avatar may include respective pieces of information of an emotion and an exercise state of the pet that are inferred using the heartbeat information and the motion information of the pet.

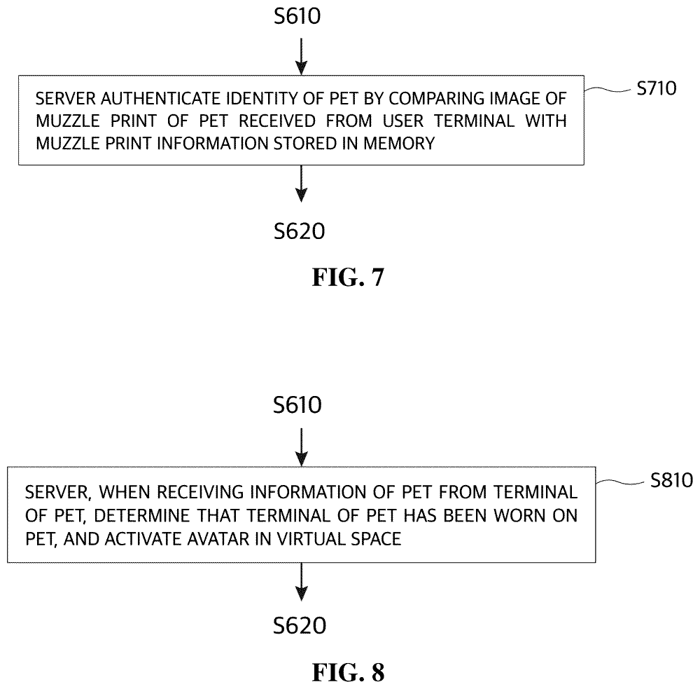

Referring to FIG. 7, according to an embodiment of the present disclosure, the pet activity monitoring and rewarding method using a metaverse may further include operation S710 in which the server authenticates the identity of the pet by comparing an image of the muzzle print of the pet received from the user terminal with the muzzle print information stored in the memory.

Referring to FIG. 8, according to an embodiment of the present disclosure, the pet activity monitoring and rewarding method using a metaverse may further include operation S810 in which, when receiving information of the pet from a terminal of the pet, the server determines that the terminal of the pet has been worn on the pet, and activates the avatar in the virtual space.

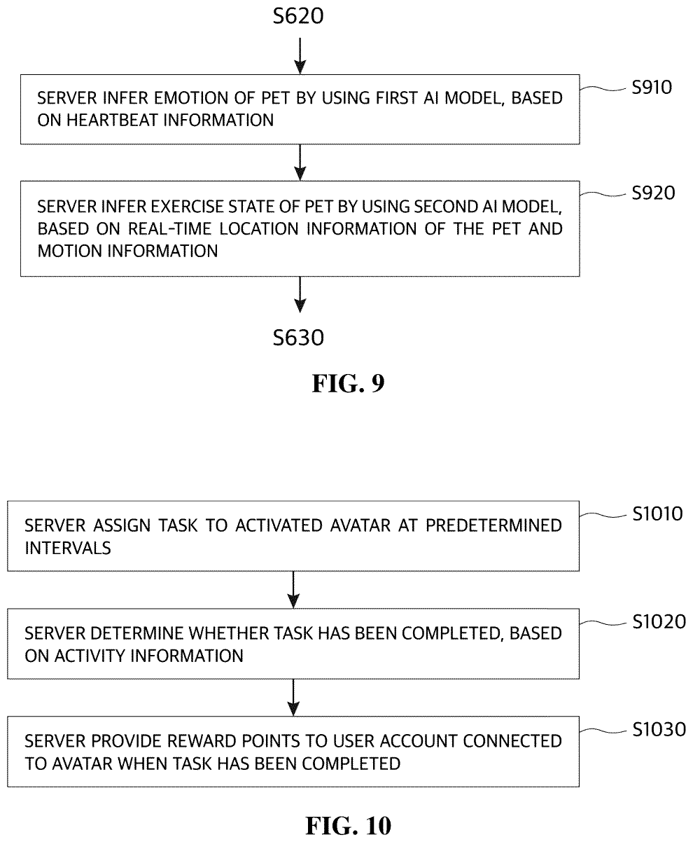

Referring to FIG. 9, according to an embodiment of the present disclosure, the pet activity monitoring and rewarding method using a metaverse may further include operation S910 in which the server infers the emotion of the pet by using a first AI model, based on the heartbeat information, and operation S920 in which the server infers an exercise state of the pet by using a second AI model, based on real-time location information of the pet and the motion information.

Referring to FIG. 10, according to an embodiment of the present disclosure, operation S630 of providing reward points to the user account may include S1010 in which the server assigns a task to the activated avatar at predetermined intervals, operation S1020 in which the server determines whether the task has been completed, based on the activity information, and operation S1030 in which the server provides reward points to a user account connected to the avatar when the task has been completed.

The server may determine the reward points in proportion to a value obtained by multiplying a value randomly selected within the range of the predetermined parameter by a weight.

In a server, system, and method for monitoring and rewarding a pet activity by using a metaverse, according the present disclosure, various activity tasks are assigned to a pet equipped with a pet terminal so that the pet may be induced to feel happy while a user is achieving the activity tasks.

In addition, when an activity task is accomplished, the user may receive reward points exchangeable for goods or services and thus encouraged to actively perform the user's task.

Moreover, because the emotion or motion information of a pet is linked to an avatar in real time, the user may monitor the pet's condition in real time even when the user and the pet are far apart from each other.

Various embodiments described herein may be implemented by hardware, middleware, microcode, software, and/or combinations thereof. For example, various embodiments may be implemented in one or more application specific semiconductors (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions presented herein, or combinations thereof.

Such hardware and the like may be implemented in the same device or in separate devices to support the various operations and functions described herein. Additionally, elements, units, modules, components, etc. described as “˜portions” or “˜units” in the present disclosure may be implemented together, or may be implemented individually as separate but interoperable logic devices. Depictions of different features of modules, units, etc. are intended to emphasize different functional embodiments, and do not necessarily imply that they must be realized by separate hardware or software components. Rather, functions associated with one or more modules or units may be performed by separate hardware components or may be integrated within common or separate hardware components.

Although the present disclosure has been described with reference to the embodiments shown in the drawings, this is merely an example. It will be understood by one of ordinary skill in the art that various modifications and equivalent other embodiments may be made without departing from the spirit and scope of the present disclosure as defined by the following claims.

### DESCRIPTION OF REFERENCE NUMERALS

100: a pet activity monitoring and rewarding method using a metaverse
110: a server
120: a pet terminal
130: a user terminal

1. A pet activity monitoring and rewarding server using a metaverse, connected to a pet terminal and a user terminal via a network to receive information of a pet, the pet activity monitoring and rewarding server comprising:
a processor and a memory,
wherein the processor is configured to:
receive the information of the pet from the user terminal through the network, store the information of the pet in the memory, and create an avatar of the pet in a virtual space to correspond to the information of the pet;
update activity information of the avatar by using the information of the pet received from the pet terminal through the network; and
provide a reward point to a user account that owns the avatar, based on the activity information of the avatar.

2. The pet activity monitoring and rewarding server of claim 1, wherein the information of the pet comprises muzzle print information of the pet, and
the avatar is created to correspond to the muzzle print information.

3. The pet activity monitoring and rewarding server of claim 2, wherein the processor compares an image of the muzzle print of the pet received from the user terminal with the muzzle print information stored in the memory to authenticate the identity of the pet.

4. The pet activity monitoring and rewarding server of claim 1, wherein
the processor receives, from the pet terminal, the information of the pet including heartbeat information and motion information of the pet, and
the motion information comprises one or more of a 3-axis acceleration signal and a 3-axis rotation signal that are measured according to a motion of the pet.

5. The pet activity monitoring and rewarding server of claim 4, wherein the activity information of the avatar comprises respective pieces of information of an emotion and an exercise state of the pet that are inferred using the heartbeat information and the motion information of the pet.

6. The pet activity monitoring and rewarding server of claim 5, wherein the processor infers an emotion of the pet by using a first artificial intelligence (AI) model, based on the heartbeat information, and infers an exercise state of the pet by using a second AI model, based on real-time location information of the pet and the motion information.

7. The pet activity monitoring and rewarding server of claim 1, wherein, when receiving information of the pet from a terminal of the pet, the processor determines that the terminal of the pet has been worn on the pet, and activates the avatar in the virtual space.

8. The pet activity monitoring and rewarding server of claim 7, wherein the processor is further configured to:
assign a task to the activated avatar at predetermined intervals;
determine whether the task has been completed, based on the activity information of the avatar; and
provide the reward points to the user account when the task has been completed.

9. The pet activity monitoring and rewarding server of claim 1, wherein the processor is further configured to determine the reward points in proportion to a value obtained by multiplying a value randomly selected within the range of a predetermined parameter by a weight.

10. A pet activity monitoring and rewarding system using a metaverse, the pet activity monitoring and rewarding system comprising:
a pet terminal mounted on a pet to obtain information of the pet;
a user terminal configured to obtain information of the pet or connected to the pet terminal to receive the information of the pet; and
a server connected to the pet terminal or the user terminal through a network and configured to receive information of the pet through the network,
wherein the server is further configured to:
receive the information of the pet from the user terminal through the network, store the information of the pet in a memory, and create an avatar of the pet in a virtual space to correspond to the information of the pet;
update activity information of the avatar by using the information of the pet received from the pet terminal through the network; and
provide a reward point to a user account that owns the avatar, based on the activity information of the avatar.

11. A pet activity monitoring and rewarding method using a metaverse, performed by a system including a server, a user terminal, and a pet terminal worn on a pet to obtain and transmit information of the pet, the pet activity monitoring and rewarding method comprising:
receiving the information of the pet from the user terminal through a network, storing the information of the pet in a memory, and creating an avatar of the pet in a virtual space to correspond to the information of the pet, wherein the receiving, the storing, and the creating are performed by the server;
updating activity information of the avatar by using the information of the pet received from the pet terminal through the network, wherein the updating is performed by the server; and
providing a reward point to a user account that owns the avatar, based on the activity information of the avatar, wherein the providing is performed by the server.

12. The pet activity monitoring and rewarding method of claim 11, wherein the information of the pet comprises muzzle print information of the pet, and
the avatar is created to correspond to the muzzle print information.

13. The pet activity monitoring and rewarding method of claim 12, further comprising comparing an image of the muzzle print of the pet received from the user terminal with the muzzle print information stored in the memory to authenticate the identity of the pet, wherein the comparing is performed by the server.

14. The pet activity monitoring and rewarding method of claim 11, wherein the information of the pet received by the server from the pet terminal comprises heartbeat information and motion information of the pet, and
the motion information comprises one or more of a 3-axis acceleration signal and a 3-axis rotation signal that are measured according to a motion of the pet.

15. The pet activity monitoring and rewarding method of claim 14, wherein the activity information of the avatar comprises respective pieces of information of an emotion and an exercise state of the pet that are inferred using the heartbeat information and the motion information of the pet.

16. The pet activity monitoring and rewarding method of claim 15, further comprising:
inferring the emotion of the pet by using a first artificial intelligence (AI) model, based on the heartbeat information; and
inferring the exercise state of the pet by using a second AI model, based on real-time location information of the pet and the motion information.

17. The pet activity monitoring and rewarding method of claim 11, further comprising, when receiving the information of the pet from a terminal of the pet, determining that the terminal of the pet has been worn on the pet, and activating the avatar in the virtual space, wherein the determining and activating is performed by the server.

18. The pet activity monitoring and rewarding method of claim 17, wherein the providing of the rewarding point to the user account comprises:
assigning a task to the activated avatar at predetermined intervals, wherein the assigning is performed by the server;
determining whether the task has been completed, based on the activity information of the avatar, wherein the determining is performed by the server; and
providing the reward point to the user account when the task has been completed, wherein the providing is performed by the server.

19. The pet activity monitoring and rewarding method of claim 11, wherein the server determine the reward points in proportion to a value obtained by multiplying a value randomly selected within the range of a predetermined parameter by a weight.
